(19) United States
(12) Patent Application Publication
(10) Pub. No.: US 2015/0135907 A1
(43) Pub. Date: May 21, 2015

(54) POWER TOOL

(71) Applicant: MAKITA CORPORATION, Anjo-shi, Aichi (JP)

(72) Inventors: Tokuo Hirabayashi, Anjo-shi (JP); Ryunosuke Kumagai, Anjo-shi (JP); Takeshi Nishimiya, Anjo-shi (JP); Goshi Ishikawa, Anjo-shi (JP); Takuya Kusakawa, Anjo-shi (JP)

(21) Appl. No.: 14/404,261

(22) PCT Filed: May 20, 2013
(86) PCT No.: PCT/JP2013/063955

§ 371 Date: Nov. 26, 2014

(30) Foreign Application Priority Data
Jun. 5, 2012 (JP) 2012-128228

(51) Int. Cl. B25B 21/00; B23Q 5/04; B23Q 15/12

(52) U.S. Cl. CPC B25B 21/008; B23Q 15/12; B23Q 5/048
USPC 81/54

(57) ABSTRACT

A power tool of one aspect for tightening a screw to a tightening-target-object is provided with a motor as a drive force. A motor controlling device controls the motor so as to make rotational frequency of the motor in accordance with an input operation received by an input-operation receiving unit. A first setting unit sets a maximum rotational frequency to a given first maximum rotational frequency when the motor is initiated. If the power tool clears a given condition for increasing rotational frequency after the motor is initiated, a second setting unit sets the maximum rotational frequency to a given second maximum rotational frequency that is larger than the first maximum rotational frequency.

### CROSS-REFERENCE TO RELATED APPLICATIONS

This international application claims the benefit of Japanese Patent Application No. 2012-128228 filed Jun. 5, 2012 in the Japan Patent Office, and the entire disclosure thereof is incorporated herein by reference.

### TECHNICAL FIELD

The present invention relates to a power tool that is rotationally driven by a motor.

### BACKGROUND ART

A screw, such as a drill screw and a wooden screw having a drill-shape screw tip, that can be tightened as the screw itself drills a hole into a tightening-target-object is known among screws that can be tightened by a power tool (see Patent Document 1 for example).

When a user of a power tool uses the power tool to tighten such screw into the tightening-target-object, the user spears the tightening-target-object with the point of the screw and pulls the trigger switch of the power tool while pressing the screw head against the tightening-target-object with the tool bit. The screw is then rotated and tightened as it drills a hole into the tightening-target-object. If it is a drill screw, the drilling part at the point of the screw opens a hole into the tightening-target-object, and then the screw is tightened as it self-taps the tightening-target-object.

Some power tools provide a mode to appropriately tighten drill screws. One famous drill screw is TEKS (registered trademark; the same applies hereinafter) screw; therefore, if, for example, a power tool with multiple modes (functions) has the above-mentioned mode for tightening drill screws, such mode is sometimes called TEKS mode.

### PRIOR ART DOCUMENTS

### Patent Documents

Patent Document 1: Japanese Unexamined Patent Application Publication No. 2010-207951

### SUMMARY OF THE INVENTION

### Problems to be Solved by the Invention

A type of screw such as the above-mentioned drill screw is however very unstable, inclined to wobble and fall off until it opens a hole into a tightening-target-object; because this type of screw basically first drills a hole into a holeless tightening-target-object.

In particular, if an initial rotational frequency is high at the time a user pulls a trigger switch, a performance of tightening tends to become worse as in wobbling and falling off of a screw at the beginning of tightening. Tightening is generally taken place as a screw is pressed against a tightening-target-object firmly with a tool bit. Therefore, if the screw falls off at the beginning of tightening, the tool bit may hit and damage the tightening-target-object.

In one aspect of the present invention, it is preferable to prevent the screw from falling off during tightening with a power tool for tightening the screw, and thereby enabling attempting an improvement in the performance of tightening.

### Means for Solving the Problems

In the first aspect, the present invention is a power tool that tightens a screw into a tightening-target-object; the power tool is provided with a motor, an input-operation receiving unit, a motor controlling device, a first setting unit, an increase-condition determiner, and a second setting unit.

The motor rotationally drives an output axis where a tool element is attached. The input-operation receiving unit receives an input operation from outside to rotate the motor. The motor controlling device controls the motor to rotate at the rotational frequency according to the input operation received by the input-operation receiving unit, wherein an upper limit is set to a preset maximum rotational frequency. The first setting unit sets the maximum rotational frequency to a given first maximum rotational frequency when the motor is initiated. The increase-condition determiner determines whether the power tool clears a given condition for increasing rotational frequency after the motor is initiated. The second setting unit sets the maximum rotational frequency to a given second maximum rotational frequency that is higher than the first maximum rotational frequency, if the condition for increasing rotational frequency is cleared.

Here, “rotational frequency” means a number of rotations per unit time, namely a rotational speed (the same applies hereinafter).

Configured as above, in the power tool of the present invention, the rotational frequency is restrained by setting the initial maximum rotational frequency at the time of initiating the motor (at the beginning of rotation) to the relatively low first maximum rotational frequency; the setting is changed to the relatively high second maximum rotational frequency, if the condition for increasing rotational frequency is cleared. For this reason, when tightening the above-mentioned drill screw, for example, a hole can be drilled into the tightening-target-object while the screw is prevented from falling off, because of the low rotational frequency at the beginning. As described above, it is possible to have a screw hard to fall off at the beginning of tightening by restraining the initial rotational frequency; thereby it is possible to attempt an improvement in overall performance of tightening.

There may be several possible conditions for increasing rotational frequency, which are criterion to determine the change of setting from the first maximum rotational frequency to the second maximum rotational frequency. A condition for increasing rotational frequency may be set, for example, based on a physical quantity related to operating state of the power tool.

In other words, a physical-quantity detector is provided for detecting one or multiple types of physical quantities related to operating state of the power tool, and if a part or all of the one or multiple types of physical quantities detected by the physical-quantity detector reach preset thresholds for each of the physical quantities, the increase-condition determiner determines that the condition for rising rotational frequency is cleared.

By means of setting a condition for increasing rotational frequency based on each physical quantity of the power tool as described above, the setting can be changed from the first maximum rotational frequency to the second maximum rotational frequency at an appropriate timing.

The above physical quantity may be any kind of physical quantity measurable (observable) in the power tool; it may be any of the following three patterns.

The first pattern is as follows. The physical-quantity detector detects a motor current as the physical quantity. The increase-condition determiner determines that the condition for increasing rotational frequency is cleared, if the motor current detected by the physical-quantity detector is equal to or more than a threshold current of the above threshold.

A point of the screw is normally just about to begin driving into the tightening-target-object immediately after tightening of the screw begins; therefore, tightening torque is relatively small and the motor current is consequently small. On the other hand, as the tightening of the screw continues and the screw drives into the tightening-target-object, the tightening torque becomes large and the motor current consequently becomes large.

By means of utilizing such changes in the motor current to appropriately set the threshold current, the setting can be changed to the second maximum rotational frequency when the screw has driven into the tightening-target-object to some extent. The setting can therefore be changed from the first maximum rotational frequency to the second maximum rotational frequency in more appropriate timing suitable for the progress of the tightening.

The second pattern is as follows. The physical-quantity detector detects a rotational frequency of the motor as the physical quantity. The increase-condition determiner determines that the condition for increasing rotational frequency is cleared, if the rotational frequency of the motor detected by the physical-quantity detector is equal to or lower than a threshold rotational frequency of the above threshold.

It is already mentioned above that the tightening torque becomes large as the tightening of the screw continues and the screw drives into the tightening-target-object. The rotational frequency of the motor is therefore reduced as a result of the increase in the tightening torque.

By means of utilizing such change in rotational frequency of the motor to appropriately set the threshold rotational frequency, the setting can be changed to the second maximum rotational frequency when the screw has driven into the tightening-target-object to some extent. The setting can therefore be changed from the first maximum rotational frequency to the second maximum rotational frequency in more appropriate timing suitable for the progress of the tightening.

The third pattern is as follows. The physical-quantity detector detects an elapsed time after initiation of the motor as the physical quantity. The increase-condition determiner determines that the condition for increasing rotational frequency is cleared, if the elapsed time detected by the physical-quantity detector is equal to or more than a threshold elapsed time of the above threshold.

When a certain amount of time has elapsed since the beginning of screw tightening, it is assumed that at least the screw tip has driven into the tightening-target-object to make the screw stable. Consequently, by appropriately setting the threshold elapsed time, the setting can be changed to the second maximum rotational frequency when the screw has driven into the tightening-target-object to some extent. The setting can therefore be changed from the first maximum rotational frequency to the second maximum rotational frequency in more appropriate timing suitable for the progress of the tightening.

The above-mentioned power tool of the present invention may further be configured with; a seating detector for detecting that a screw rotated by a tool element is seated on the tightening-target-object; and a third setting unit for setting the maximum rotational frequency to a given third maximum rotational frequency that is lower than the second maximum rotational frequency, if the screw is detected seated by the seating detector after the second setting unit sets the maximum rotational frequency to the second maximum rotational frequency.

Thus, by reducing the rotational frequency when the screw is seated, excessively firm tightening of the screw after seating can be reduced and the tightening can be finished in a favorable condition.

The motor may also be stopped, if the seating detector detects seating of the screw. Thus, by stopping the rotation when the screw is seated, the tightening can be finished in a more favorable condition.

### BRIEF DESCRIPTION OF THE DRAWINGS

FIG. 1 is a perspective view illustrating an exterior appearance of a power tool according to embodiments.

FIG. 2A to FIG. 2E are explanatory illustrations showing that ON/OFF status of two selector switches change as an operational mode is changed by a mode-change ring.

FIG. 3 is a block diagram illustrating configuration of the entire driving system of the power tool.

FIG. 4 is a flowchart illustrating a motor control process executed by a controller.

FIG. 5 is a flowchart specifying a process of changing a set rotational frequency at step S140 of FIG. 4.

FIG. 6 is an explanatory illustration showing an example of changes in motor current and rotational frequency when operating in TEKS mode.

FIG. 7 is a flowchart illustrating another embodiment of the motor control process.

FIG. 8 is an explanatory illustration showing another embodiment of an example for changes in motor current and rotational frequency when operating in the TEKS mode.

FIG. 9 is a flowchart illustrating a variation of the process of changing set rotational frequency.

FIG. 10 is a flowchart illustrating a variation of the process of changing set rotational frequency.

### EXPLANATION OF REFERENCE NUMERALS

1 . . . power tool, 2-3 . . . half-split housing, 4 . . . handle, 5 . . . main-body housing, 6 . . . battery pack, 7 . . . motor storage, 8 . . . sleeve, 9 . . . LED lighting, 10 . . . trigger switch, 11 . . . forward-reverse switch, 12 . . . mode-change ring, 13 . . . arrow, 14 . . . battery, 15 . . . switch pressing member, 16 . . . first selector switch, 17 . . . second selector switch, 20 . . . motor, 21 . . . impact mark, 22 . . . vibration-drill mark, 23 . . . drill mark, 24 . . . clutch mark, 25 . . . TEKS mark, 30 . . . operation view panel, 31 . . . controller, 32 . . . gate circuit, 33 . . . motor drive circuit, 34 . . . rotation-position sensor, 35 . . . shunt resistor, 36 . . . regulator, 41 . . . CPU, 42 . . . ROM, 43 . . . RAM, 44 . . . flash memory.

### MODE FOR CARRYING OUT THE INVENTION

A preferred embodiment of the present invention is described below with reference to the drawings.

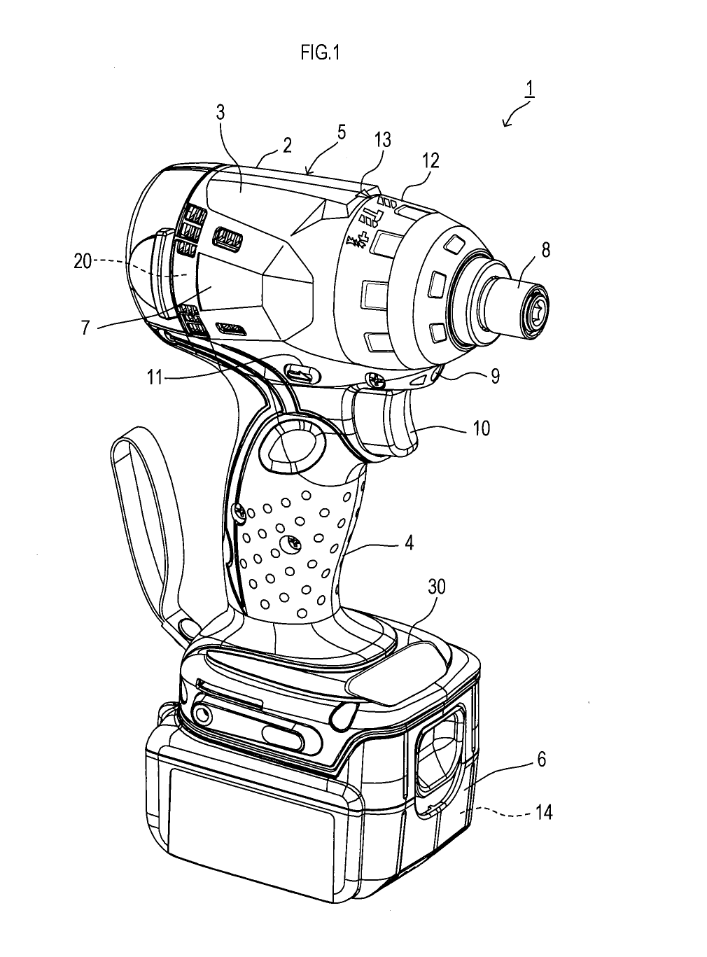

A power tool 1 according to the present embodiment is configured as a rechargeable 5-mode impact driver that can operate in five operational modes as illustrated in FIG. 1.

To be more specific, the power tool 1 is configured with a main-body housing 5 and a battery pack 6. The main-body housing 5 is formed by assembling half-split housings 2 and 3. A handle 4 is provided extending on the lower part of the main-body housing 5. The battery pack 6 is detachably coupled to the bottom end of this handle 4.

A motor storage 7 for storing a motor 20 is disposed at the rear of the main-body housing 5; the motor 20 is a drive force for the power tool 1. A multiple types of transmission mechanisms (omitted in drawings) for transmitting rotation of the motor 20 to the tool-point side is stored closer to the front than the motor storage 7. A sleeve 8 is disposed to project from the head of the main-body housing 5; the sleeve 8 is for installing a tool bit (for example, a driver bit), which is one of examples of the tool elements and not shown in the drawings.

A trigger switch 10 is disposed to the front of the upper-end of the handle 4 on the main-body housing 5. Trigger switch 10 is a switch operable by a user (operator) of the power tool 1 in order to operate the power tool 1 by rotationally driving the motor 20, while the user grabs the handle 4. A forward-reverse switch 11 for changing the rotational direction of the motor 20 is disposed to the center of the upper-end of the handle 4 on the main-body housing 5.

In addition, a mode-change ring 12 is disposed at the front of the main-body housing 5; the mode-change ring 12 is turned (displaced) by a user in order to set the power tool 1 to any operational mode.

The mode-change ring 12 is a ring-shape member arranged at the front of the main-body housing 5 approximately coaxially with the axis of the sleeve 8, and is rotatable around its own axis. Five marks referring to five varieties of operational modes are arranged in sequence on a partial area of the surface of this mode-change ring 12 along the circumferential direction. A triangle arrow 13 is formed on the top surface of the main-body housing 5 at the rear of the mode-change ring 12.

A user of the power tool 1 can operate the power tool 1 in a desired mode by turning this mode-change ring 12 to bring the mark for the desired mode to the point of the arrow 13.

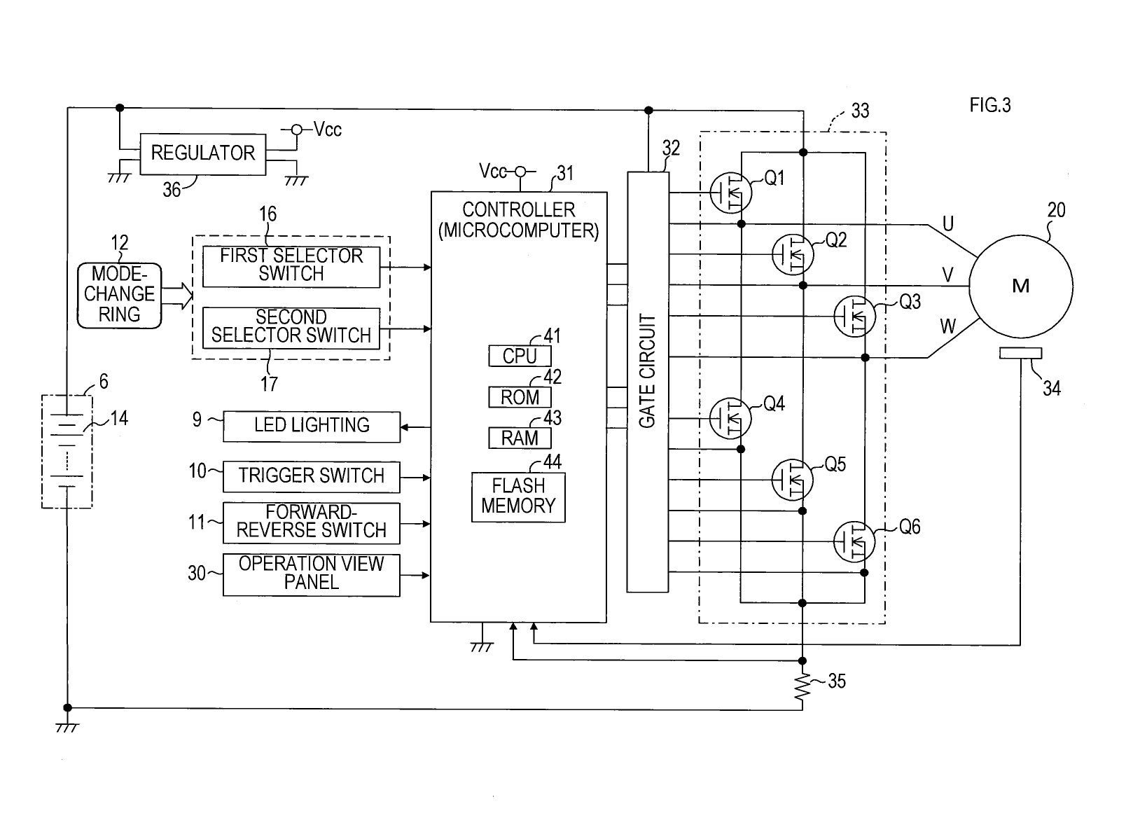

A battery 14 is disposed inside the battery pack 6; the battery 14 is configured with serially connected secondary battery cells for generating a given direct current voltage. A motor controlling device (including a controller 31, a gate circuit 32, and a motor drive circuit 33, etc., described hereinafter; see FIG. 3) is placed inside the handle 4. The motor controlling device operates by receiving power supply from the battery 14 disposed inside the battery pack 6, and rotates the motor 20 according to an operated amount of the trigger switch 10.

The motor 20 does not start rotating immediately when the trigger switch 10 is pulled for operation at all; the motor 20 does not rotate until a given amount (however, only a small amount) is pulled for operation since the beginning of the pull. When the pulled amount exceeds the given amount, the motor 20 begins rotating and consequently increases its rotational frequency (rotational speed) according to the pulled amount (for example, almost in proportion to the pulled amount). When the trigger switch 10 is pulled to a given position (for example, when it is pulled completely), the rotational frequency of the motor 20 reaches a set upper limit of the rotational frequency.

An LED lighting 9 is disposed to the main-body housing 5 above the trigger switch 10; the LED lighting 9 is for illuminating in front of the power tool 1 by a light. This LED lighting 9 lights up when a user operates the trigger switch 10.

An operation view panel 30 is disposed at a lower edge of the handle 4; the operation view panel 30 is for displaying various information and receiving operational input of the power tool 1, for example, displaying various set-values, receiving operations for changing settings, and displaying remaining level of the battery 14. An explanation of the detailed configuration of the operation view panel 30 is omitted.

The power tool 1 according to the present embodiment includes five operational modes as its operational modes; impact mode (rotation+strike in the rotational direction), vibration-drill mode (rotation+strike in the axial direction), drill mode (rotation only), clutch mode (rotation+electronic clutch), and TEKS mode (rotation+change in rotational frequency+strike). A user can set a desired operational mode by operating the mode-change ring 12.

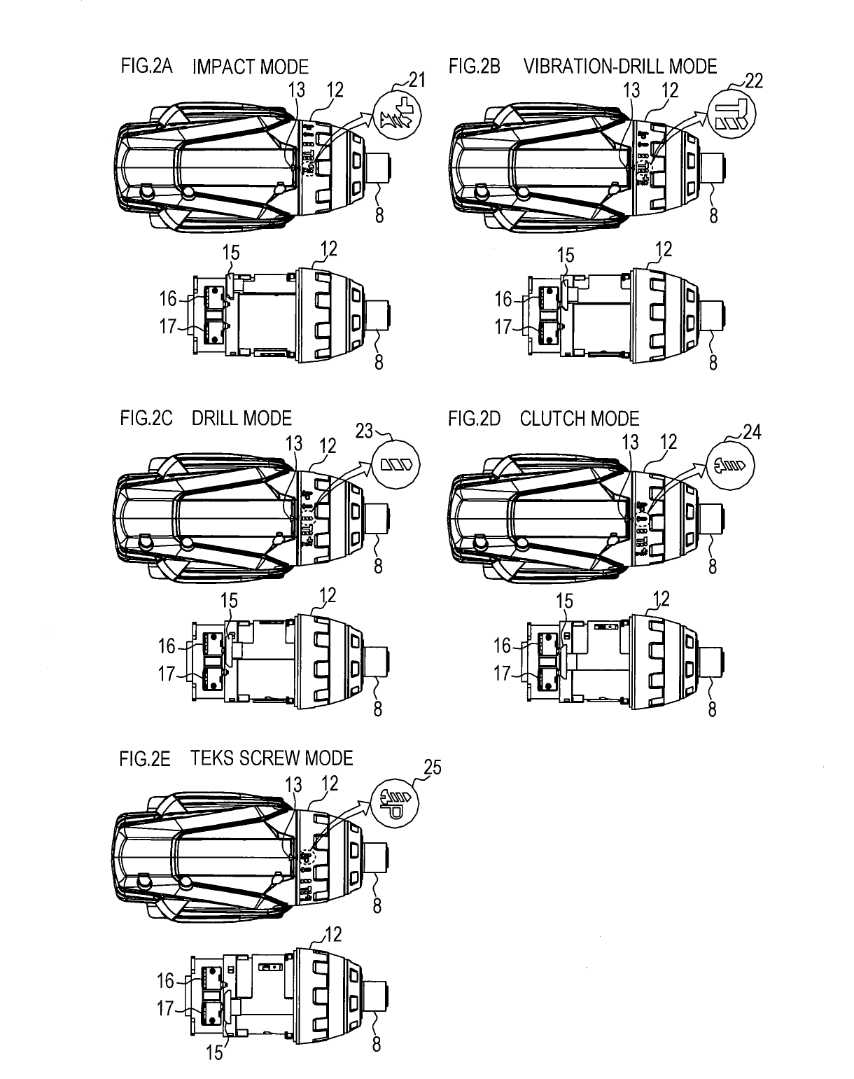

A switch pressing member 15 is coupled to the mode-change ring 12 as illustrated in FIGS. 2A to 2E; the switch pressing member 15 integrally turns with the turn of the mode-change ring 12. FIGS. 2A to 2E indicate positions of the mode-change ring 12 corresponding to each of the five operational modes of the power tool 1. For each of the FIGS. 2A to 2E, the upper figure is a top view of the power tool 1, and the lower figure is a top view of the power tool 1 with an illustration showing inside the tool (inside the main-body housing 5) for the area behind the mode-change ring 12.

As illustrated in FIGS. 2A to 2E, a first selector switch 16 and a second selector switch 17 are adjacently arranged at the top-rear-end inside the main-body housing 5 along the turning direction of the switch pressing member 15 so as to face the switch pressing member 15.

Each of the selector switches 16 and 17 are both known contact switches (limit switches), which are configured so that a contact point thereof contacts or separates depending on a position of a movable part in front-rear direction, the movable part is disposed on a surface facing the tool point. Each of the selector switches 16 and 17 are turned on and off by the switch pressing member 15 depending on a position of the switch pressing member 15 that integrally moves with the turn of the mode-change ring 12 operated by a user.

When not pressed by the switch pressing member 15, each movable part disposed to each of the selector switches 16 and 17 is projected towards the tool point because of a biasing force from an unillustrated biasing member. In this state, the contact points inside are separated and a circuit is electrically off. Meanwhile, when the switch pressing member 15 abuts each of the movable parts, a load from the switch pressing member 15 presses each of the movable parts towards the rear-end of the tool; thereby the contact points inside contact and the circuit is electrically on. Each of the selector switches 16 and 17 output an electrical signal that indicates on and off status of each switch.

With configurations as above, if a user tries to set the operational mode to, for example, the impact mode, and turns the mode-change ring 12 to bring the impact mark 21 to the point of the arrow 13 as illustrated in FIG. 2A, the transmission mechanism that transmits rotational driving force of the motor 20 to the sleeve 8 is changed to a transmission mechanism corresponding to the impact mode (a mechanism that generates a striking force, if the applied torque is equal to or more than a given level), in the main-body housing 5. Further in this state, the switch pressing member 15 is positioned apart from both of the selector switches 16 and 17; therefore, both of the selector switches 16 and 17 are off.

If a user tries to set the operational mode to, for example, the vibration-drill mode, and turns the mode-change ring 12 to bring the vibration-drill mark 22 to the point of the arrow 13 as illustrated in FIG. 2B, the transmission mechanism that transmits rotational driving force of the motor 20 to the sleeve 8 is changed to a transmission mechanism corresponding to the vibration-drill mode (a mechanism that generates strikes (vibration) in the axial direction while rotating), in the main-body housing 5. Further in this state, the switch pressing member 15 abuts the movable part of the first selector switch 16 among selector switches 16 and 17; therefore, the first selector switch 16 is on and the second selector switch 17 is off.

If a user tries to set the operational mode to, for example, the drill mode, and turns the mode-change ring 12 to bring the drill mark 23 to the point of the arrow 13 as illustrated in FIG. 2C, the transmission mechanism that transmits rotational driving force of the motor 20 to the sleeve 8 is changed to a transmission mechanism corresponding to the drill mode (a mechanism that maintains or reduces the rotational driving force of the motor and transmits the force to sleeve 8), in the main-body housing 5. Further in this state, the switch pressing member 15 abuts the movable part of the first selector switch 16 among selector switches 16 and 17; therefore, the first selector switch 16 is on and the second selector switch 17 is off.

If a user tries to set the operational mode to, for example, the clutch mode, and turns the mode-change ring 12 to bring the clutch mark 24 to the point of the arrow 13 as illustrated in FIG. 2D, the transmission mechanism that transmits rotational driving force of the motor 20 to the sleeve 8 is changed to a transmission mechanism corresponding to the clutch mode (same as the drill mode), in the main-body housing 5. Further in this state, the switch pressing member 15 abuts the movable part of each of the selector switches 16 and 17; therefore, both of the selector switches 16 and 17 are on.

The clutch mode is the same as the drill mode as to transmission mechanism, but different from the drill mode as to control contents of the motor 20. In the drill mode, it is controlled to constantly generate rotational driving force while the trigger switch 10 is pulled for operation; in the clutch mode, the rotation of the motor 20 is stopped when the torque of the motor 20 is equal to or more than a given set torque level.

If a user tries to set the operational mode to, for example, the TEKS mode, and turns the mode-change ring 12 to bring the TEKS mark 25 to the point of the arrow 13 as illustrated in FIG. 2E, the transmission mechanism that transmits rotational driving force of the motor 20 to the sleeve 8 is changed to a transmission mechanism corresponding to the TEKS mode (same as the impact mode), in the main-body housing 5. Further in this state, the switch pressing member 15 abuts the movable part of the second selector switch 17 among the selector switches 16 and 17; therefore, the second selector switch 17 is on and the first selector switch 16 is off.

The TEKS mode is an operational mode designed to tighten a drill screw, based on the operation for the impact mode. In the TEKS mode, the motor 20 is rotated at a low speed at the beginning of tightening, wherein the upper limit is a given first set rotational frequency N1. If a given condition for increasing rotational frequency is subsequently cleared, the upper limit of rotational frequency is changed to a second set rotational frequency N2 that is higher than the first set rotational frequency N1. Further, after the drill screw is seated on the tightening-target-object (hereinafter abbreviated to “target material”), the upper limit of rotational frequency is changed to a third set rotational frequency N3 that is lower than the second set rotational frequency N2. Detailed control contents of the motor 20 in the TEKS mode are hereinafter described.

Thus, by providing the mode-change ring 12 and enabling changing the operational modes through operation of this mode-change ring 12, it is possible in the operation view panel 30 to set functions other than changing the operational modes. Number of switches to arrange in the operation view panel 30 can consequently be reduced, and thus the operation view panel 30 can be placed in a saved space.

The next is an explanation of the motor controlling device that is provided inside the power tool 1 to control rotational drive of the motor 20, with reference to FIG. 3. As illustrated in FIG. 3, the motor controlling device is a device for rotationally driving the motor 20 by supplying direct-current power to the motor 20 from the battery 14, which is disposed inside the battery pack 6. More specifically, the motor controlling device includes the controller 31, the gate circuit 32, the motor drive circuit 33, and a regulator 36.

The motor 20 in this embodiment is configured as a three-phase brushless DC motor, wherein terminals U, V, and W of the motor 20 are coupled with the battery pack 6 (more specifically, with the battery 14) via a motor drive circuit 33. The terminals U, V, and W are each coupled with any one of three unillustrated coils, which are disposed to the motor 20 in order to rotate an unillustrated rotor of the motor 20.

The motor drive circuit 33 is configured to be a bridge circuit including three switching elements Q1 to Q3 and three switching elements Q4 to Q6; the switching elements Q1 to Q3 are so called high-side switches connecting each of the terminals U, V, and W of the motor 20 with the positive-electrode of the battery 14, and likewise, the switching elements Q4 to Q6 are so called low-side switches connecting each of the terminals U, V, and W of the motor 20 with the negative-electrode of the battery 14. The switching elements Q1 to Q6 in this embodiment are known MOSFETs.

The gate circuit 32 is coupled with the controller 31 while also coupled with each gate and source of the switching elements Q1 to Q6. The gate circuit 32 turns on/off each of the switching elements Q1 to Q6 by means of applying switching voltages between the gate and the source of each of the switching elements Q1 to Q6 based on a control signal input from the controller 31 to the gate circuit 32; the switching voltages are for turning on/off each of the switching elements Q1 to Q6, and the control signal is for controlling on/off of each of the switching elements Q1 to Q6.

The regulator 36 lowers a direct-current voltage of the battery 14 and generates a control voltage Vcc (for example, 5V) that is a given direct-current voltage, and supplies the generated control voltage Vcc to each part inside the motor controlling device including the controller 31.

The controller 31 is configured to be a so called one-chip micro computer as an example in this embodiment, the controller 31 contains a CPU 41, a ROM 42, a RAM 43, and a flash memory 44. The controller 31 further contains an input/output (I/O) port, an A/D converter, timer, and so forth, although illustrations thereof are omitted.

The controller 31 is coupled with the above-mentioned each of the selector switches 16 and 17, LED lighting 9, trigger switch 10, forward-reverse switch 11, operation view panel 30, a rotation-position sensor 34 disposed to the motor 20, and a shunt resistor 35 serially inserted into a conductive path of the motor 20.

The rotation-position sensor 34 includes a hall element, and is configured to output a pulse signal to the controller 31 every time the rotational position of the rotor of the motor 20 reaches to a given rotational position (i.e., every time the motor 20 rotates a given amount). The controller 31 then calculates the actual rotational position and rotational frequency of the motor 20 based on the pulse signal from the rotation-position sensor 34, and utilizes the result of this calculation in motor control.

As mentioned above, electrical signals indicating each status (on or off) are inputted from each of the selector switches 16 and 17 to the controller 31. Based on the each inputted electrical signal, the controller 31 determines an operational mode to which the power tool 1 is set and controls the motor 20 with a control method based on the determined outcome.

In this embodiment, three types of controlling methods to control the motor 20 by the controller 31 are set: single control, electronic clutch control, and TEKS control. The controller 31 uses the single control, if the operational mode is set to the impact mode, drill mode, or vibration-drill mode; uses the electronic clutch control, if the operational mode is set to the clutch mode; and uses the TEKS mode, if the operational mode is set to the TEKS mode.

The single control is a controlling method to rotate the motor 20 at a rotational frequency according to the amount the trigger 10 is pulled by a user (operated amount), wherein the upper limit is a preset maximum rotational frequency (hereinafter referred to as “set rotational frequency”).

To be more precise, the trigger switch 10 in this embodiment contains a drive-initiation switch for detecting whether the trigger switch 10 is pulled, and a known variable resistor (for example, a known potentiometer) for detecting the pulled amount of the trigger switch 10. When the trigger switch 10 is pulled for operation, an analog signal according to the pulled amount is inputted to the controller 31 from the trigger switch 10.

Thus in the single control, the controller 31 controls the motor 20 so that the motor 20 rotates at a rotational frequency according to the pulled amount indicated by the analog signal inputted from the trigger switch 10. More specifically, the controller 31 sets a duty ratio of a voltage (driving voltage) applied to each of the terminals U, V, and W of the motor 20 via the gate circuit 32 and motor drive circuit 33, wherein the upper limit is the preset rotational frequency; so that the larger the pulled amount of the trigger switch 10 is, the more the rotational frequency increases. One example in this embodiment is to perform PWM control so that the rotational frequency increases in proportion to the pulled amount of the trigger switch 10 and reaches to the preset rotational frequency when the pulled amount is at its maximum.

The electronic clutch control is a controlling method basically for controlling the motor 20 to rotate at a rotational frequency according to the pulled amount of the trigger switch 10, likewise the single control. The electronic clutch control further monitors rotational torque of a tool bit (rotational torque of the sleeve 8), and stops the rotation of the motor 20 when the rotational torque is equal to or more than a given set torque value.

In this embodiment, the rotational torque of the tool bit is not directly detected; the rotational torque of the tool bit is indirectly detected by detecting an output torque of the motor 20. Particularly, voltage is inputted into the controller 31 from the end opposite to the ground potential end of the shunt resistor 35, which is disposed on the conductive path of the motor 20. The controller 31 detects the output torque of the motor 20 based on this voltage inputted from the shunt resistor 35.

The TEKS control is an operational mode suitable for tightening a drill screw and is a controlling method basically for PWM-controlling the motor 20 at a rotational frequency according to a pulled amount of the trigger switch 10, wherein the preset rotational frequency is the upper limit, likewise the single control. While based on such control, further in the TEKS control is that the set rotational frequency is changed to the three phases of N1, N2, and N3, according to the progress of tightening as already mentioned.

If a drill screw is rotated in high rotational frequency from the beginning of tightening when being tightened to a target material, the drill screw wobbles to fall off and makes the performance worse as already mentioned. Thus in this embodiment, the initial preset rotational frequency after the trigger switch 10 is turned on is set to the relatively low first set rotational frequency N1. It is thus possible to prevent the performance from worsening and allow the drill screw to stably drive into the target material by restraining the initial (at the time of initiating the motor) rotational frequency as described.

When a hole is opened in the target material and the tip of the drill screw drives into the target material (even further to when a tapping of the target material begins), the drill screw is in relatively stable condition and difficult to fall off. Thus, in this embodiment, it is detected that a phase has started tapping as a hole is open in the target material (corresponds to an example of the condition for increasing rotational frequency in this invention), and if it is detected that the phase has started tapping, the set rotational frequency is increased to the second set rotational frequency N2. Consequently, it is possible to expeditiously tighten the screw.

Various methods are possible for specifically detecting that the phase has come to begin tapping; in this embodiment, it is determined based on a current value of the motor 20. The controller 31 detects the motor current based on the voltage input from the shunt resistor 35 and a resistance value of the shunt resistor 35.

A point of the screw is just about to begin driving into the target material immediately after the tightening of the screw begins; therefore, tightening torque is relatively small and the motor current is consequently small. On the other hand, as the tightening of the screw continues and the tapping begins, the tightening torque becomes larger and the motor current consequently becomes larger.

A rotational-frequency-increase threshold I1 is therefore preset in this embodiment based on a motor current value assumable at the time tapping begins. When the motor current becomes equal to or more than the rotational-frequency-increase threshold I1 after the motor 20 is initiated, the set rotational frequency is increased to the second set rotational frequency N2, determining that the screw has been stabilized as the tightening of the screw continues.

As the tightening of the screw further continues, the screw is eventually seated on the target material. If the screw remains rotated at the same second set rotational frequency N2 even after being seated, it may cause troubles such as crushing the screw head because of an excessive torque applied. In this embodiment, the set rotational frequency is therefore reduced to the third set rotational frequency N3, if the screw is detected seated.

Seating of the screw is detected based on the motor current in this embodiment. Tapping advances as the tightening of the screw continues after changing to the second set rotational frequency N2; therefore the tightening torque gradually increases and the motor current also gradually increases.

A seating-detecting-current threshold I2 is therefore preset in this embodiment based on the motor current value assumable at the time the screw is seated. When the motor current becomes equal to or more than this seating-detecting-current threshold I2 after changing to the second set rotational frequency N2, the set rotational frequency is reduced to the third set rotational frequency N3 determining that the screw is seated. Detecting the seating of the screw based on the motor current is merely an example; the seating may be detected by other methods.

Specific values for each of the set rotational frequencies N1, N2, and N3 as well as for each of the current thresholds I1 and I2 are appropriately set by, for example, experimental or theoretical designs. With regard to the first set rotational frequency N1, for instance, a rotational frequency, which allows drilling of a hole into the target material while preventing the screw from falling off in an initial phase of tightening as much as possible, can be appropriately set as the first set rotational frequency N1, giving consideration to types of target materials and screws assumed at the time of tightening as well as work conditions during tightening by a user, etc.

Correlations in size between the above three set rotational frequencies N1, N2, and N3 is summarized as N1<N2, and N3<N2. Meanwhile, correlation in size between N1 and N3 can be appropriately set including setting both equal. In this embodiment, each of the set rotational frequencies N1, N2, and N3 as well as each of the current thresholds I1 and I2 are stored in the flash memory 44 disposed to the controller 31.

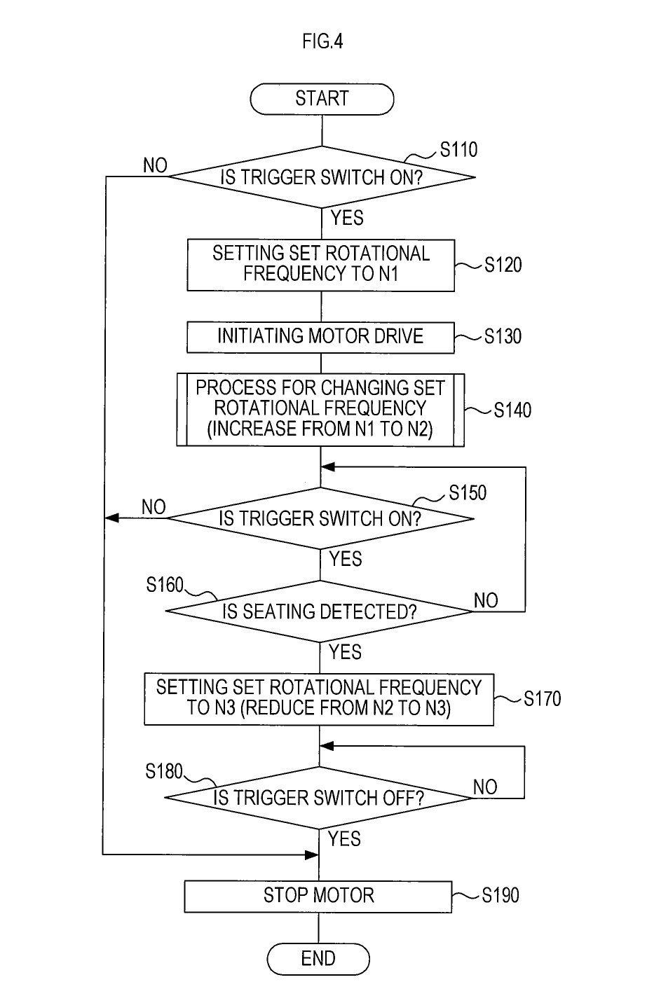

Among the various control processes executed by the controller 31, the next is an explanation, with reference to FIG. 4, of a motor control process that is executed when the operational mode is set to the TEKS mode. A program for the motor control process as in FIG. 4 is stored in the ROM 42 (or the flash memory 44) inside the controller 31. When the CPU 41 begins its operation as power is supplied, the CPU 41 regularly executes this motor control process.

When this motor control process begins, the CPU 41 in the controller 31 first determines at step S110 whether the trigger switch 10 is turned on. If the trigger switch 10 is off, the process proceeds to step S190 and the motor 20 is stopped. If the trigger switch 10 is off at step S110, it normally means that the motor 20 must be stopped in the first place; nevertheless, even in this case, the process ends after undergoing the stop control at step S190 for confirmation.

If it is determined at step S110 that the trigger switch 10 is turned on, the set rotational frequency is set to the first set rotational frequency N1 at step S120 and motor drive begins at step S130. More specifically, the motor 20 is PWM controlled so as to make the rotational frequency in accordance with the pulled amount of the trigger switch 10, wherein the upper limit is the first set rotational frequency N1.

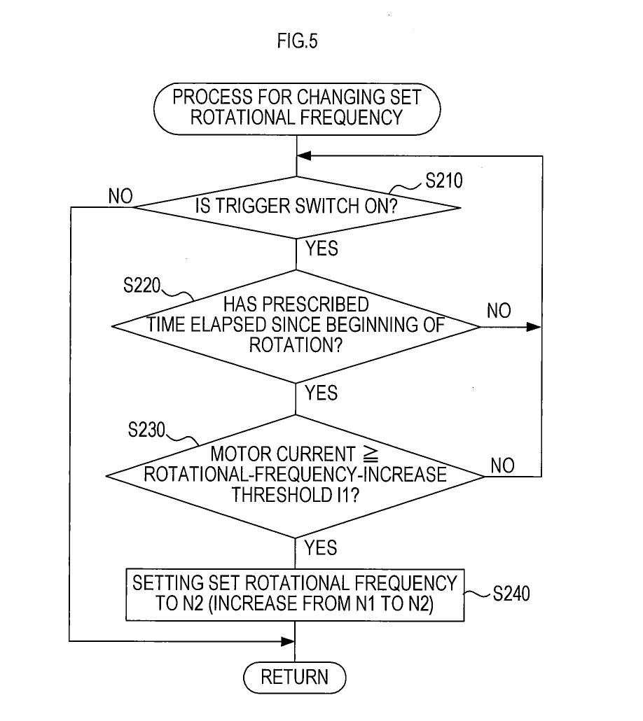

After beginning (initiating) the drive of the motor 20, a process of changing the set rotational frequency is executed at step S140. This process is for changing the set rotational frequency from N1 to N2; detail of the process is as illustrated in FIG. 5. Specifically, it is determined first at step S210 whether the trigger switch 10 is turned on. If the trigger switch 10 is off, the process moves on to step S150 (FIG. 4); if the trigger switch 10 is on, it is determined at step S220 whether a prescribed time has elapsed since the beginning of rotation.

The process goes back to step S210 from S220 until the prescribed time elapses since the beginning of rotation; when the prescribed time has elapsed since the beginning of rotation, the process moves on to step S230 from S220 and it is determined whether the motor current is equal to or more than the rotational-frequency-increase threshold I1.

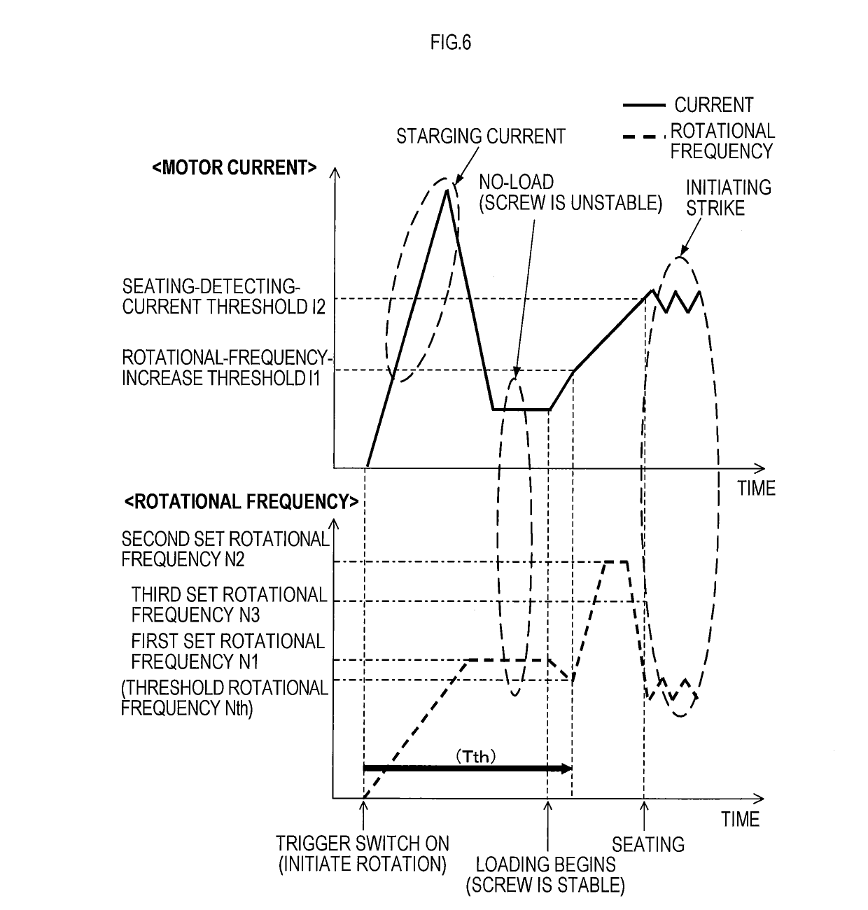

As described above, the determining process at step S230 is executed not immediately after the initiation but after the prescribed time has elapsed since the initiation; the reason is to exclude an excessive starting current (inrush current), which transiently flows immediately after the initiation, from the subject of determination at step S230. As illustrated in the upper figure of FIG. 6, a large starting current flows in the motor 20 immediately after rotation of the motor 20 begins as the trigger switch 10 is turned on. In order to prevent the set rotational frequency from being mistakenly changed to the second set rotational frequency N2 because of the starting current, the determining process at step S230 needs to be executed after this starting current is settled. In this embodiment, the determining process at step S230 is therefore executed after the prescribed time has elapsed since the initiation.

Specific length of the prescribed time may be appropriately decided. The prescribed time may be decided to, for example, a time in which at least the motor current is assumed to be within the level lower than the rotational-frequency-increase threshold I1, based on transient characteristics and such of the motor 20 at the initiation.

It is yet one example of methods for removing influence of the starting current to execute the determining process of step S230 after the prescribed time has elapsed since the initiation as described above; the influence of the starting current may be removed by other methods. For example, the determining process at step S230 may be executed after confirming that the motor current exceeds the threshold once after the initiation, and drops below the threshold again.

During the time the motor current is less than the rotational-frequency-increase threshold I1 in the determining process at step S230, the process goes back to step S210. On the other hand, when the motor current becomes equal to or more than the rotational-frequency-increase threshold I1, the process moves on to step S240, and the set rotational frequency is set to the second set rotational frequency N2. In other words, the set rotational frequency is increased from N1 to N2.

Then the process moves on to step S150 (FIG. 4) and it is determined again whether the trigger switch 10 is turned on. If the trigger switch 10 is off, the process moves on to step S190 to stop the motor 20. On the other hand, if the trigger switch 10 is on, it is determined at step S160 whether the seating of the screw is detected. Specifically, it is determined based on whether the motor current is equal to or more than the seating-detecting-current threshold I2 as already described. During the time that the motor current is less than the seating-detecting-current threshold I2, the process goes back to step S150 supposing that the screw is not yet seated. On the other hand, if the motor current becomes equal to or more than the seating-detecting-current threshold I2, it is determined that the screw is seated. The set rotational frequency is then set to the third set rotational frequency N3 at step S170. In other words, the set rotational frequency is reduced from N2 to N3.

It is determined again at step S180 whether the trigger switch 10 is turned on and this determining process is repeated at step S180 during the time that the trigger switch 10 is on (i.e., continues the rotation at the third set rotational frequency N3). If the trigger switch 10 is turned off, on the other hand, the process moves on to step S190 to stop the motor 20 and end the process.

Here is an explanation, with reference to FIG. 6, about a specific example of changes in motor current and rotational frequency in the TEKS mode, in which the motor 20 is controlled by the foregoing motor control process. An example shown in FIG. 6 illustrates when a drill screw is tightened to a target material (for example, a steel plate) by setting the power tool 1 in the TEKS mode and pulling the trigger switch 10 to its maximum. In FIG. 6, the upper figure shows the motor current and the lower figure shows the rotational frequency of the motor 20.

In terms of the motor current, when the trigger switch 10 is turned on and the rotation of the motor 20 begins, a large starting current flows transiently, but immediately afterwards, the current value drops down to the steady state as illustrated in FIG. 6. In terms of the rotational frequency of the motor, it gradually rises after the initiation and eventually reaches to the first set rotational frequency N1. It then remains in no-load condition (a condition where the tightening torque is very small) until a hole is opened in the target material. During this time, the drill screw is unstable, and prone to wobble to fall off. In this embodiment, however, because the initial set rotational frequency is restrained, the screw is difficult to fall off to that extent.

When a drilling part of the point of a TEKS screw drills a hole and drives into the target material and a phase has started tapping to the target material, load on the motor 20 gradually increases from the no-load condition. In other words, the tightening torque becomes larger. This change (increase) in the tightening torque appears as changes in both of the motor current and the rotational frequency of the motor. In particular, the motor current increases and the rotational frequency of the motor decreases as shown in FIG. 6.

If the motor current reaches the rotational-frequency-increase threshold I1, the set rotational frequency is set to the second set rotational frequency N2; as a result, the rotational frequency of the motor 20 increases to that second set rotational frequency N2. With respect to the motor current, because the tightening torque increases as the tightening advances, the motor current also increases.

If the seating of the screw is detected as a consequence of the motor current reaching the seating-detecting-current threshold I2, the set rotational frequency is set to the third set rotational frequency N3. Although the set rotational frequency is set to the third set rotational frequency N3, the actual rotational frequency is lower than the third set rotational frequency N3 as shown in FIG. 6, because the load becomes very large after the seating and the rotation of the motor 20 is thus reduced.

If the tightening toque further increases after the seating, strike operation begins. That is to say, intermittent strikes in the rotational direction of the screw begin likewise the impact mode, and thereby, the screw is tightened even more firmly.

A threshold rotational frequency Nth and a threshold elapsed time Tth described in FIG. 6 will be explained later.

In the power tool 1 in this embodiment, when in the TEKS mode, the initial rotational frequency is restrained at the time of initiating the motor 20 (when the rotation begins) by setting the set rotational frequency to the relatively low first set rotational frequency N1 as described above. If the condition for increasing rotational frequency is cleared after the initiation (i.e., if the motor current becomes equal to or more than the rotational-frequency-increase threshold I1), the setting is changed to the relatively high second set rotational frequency N2. It is thus possible to have the screw difficult to fall off at the beginning of the tightening by restraining the initial set rotational frequency as seen above; thereby enabling attempting an improvement in overall performance of tightening the drill screw.

The change of setting from the first set rotational frequency N1 to the second set rotational frequency N2 is conducted based on the motor current. It is possible to change the setting to the second set rotational frequency N2 when the screw has driven into the target material to some extent (in a state that the screw is stable and hard to fall off) by appropriately setting the rotational-frequency-increase threshold I1. The setting can therefore be changed from the first set rotational frequency to the second set rotational frequency in more appropriate timing suitable for progress of the tightening.

It is configured to reduce the set rotational frequency to the third set rotational frequency N3, if the seating of the screw is detected; therefore, an excessively firm tightening after the seating can be reduced and thus the tightening can be finished in a favorable condition.

In this embodiment, the rotational-frequency-increase threshold I1 is equivalent to an example of a threshold current of the present invention; the trigger switch 10 is equivalent to an example of an input-operation receiving unit of the present invention; the controller 31 is equivalent to an example of a motor controlling device, a first setting unit, an increase-condition determiner, a second setting unit, a seating detector, and a third setting unit of the present invention; and the shunt resistor 35 is equivalent to an example of a physical-quantity detector of the present invention.

In the motor control process in FIG. 4, the process at step S120 is equivalent to an example of a process executed by the first setting unit of the present invention; the process at step S160 is equivalent to an example of a process executed by the seating detector of the present invention; and the process at step S170 is equivalent to an example of a process executed by the third setting unit of the present invention. In the process of changing set rotational frequency in FIG. 5, the process at step S230 is equivalent to an example of a process executed by the increase-condition determiner of the present invention; and the process at step S240 is equivalent to an example of a process executed by the second setting unit of the present invention.

[Variation]

The mode for carrying out the present invention was explained hereinbefore; it is still not at all limited to the aforementioned embodiment. Needless to say, various modes may be employed as long as they are within the technical scope of this invention.

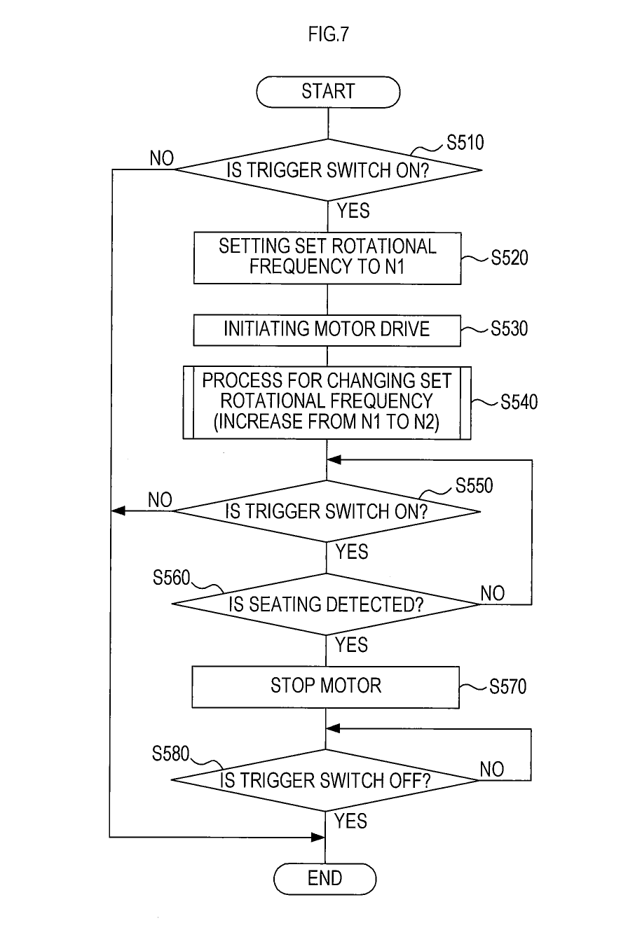

For example, in the motor control process in the aforementioned embodiment (see FIG. 4), it is controlled to reduce the set rotational frequency from the second set rotational frequency N2 to the third set rotational frequency N3, if the seating of the screw is detected at step S160; nevertheless, it may be controlled to stop the rotation of the motor 20, if the seating is detected. Such a control can be put into practice by, for example, a motor control process shown in FIG. 7.

The processes from step S510 to S560 of the motor control process in FIG. 7 are the same as the processes from step S110 to S160 of the motor control process in FIG. 4. In the motor control process in FIG. 7, if the seating is detected at step S560, the process moves on to step S570 to stop the motor 20. If the trigger switch 10 is turned off after the motor stops (S580: YES), this motor control process is ended.

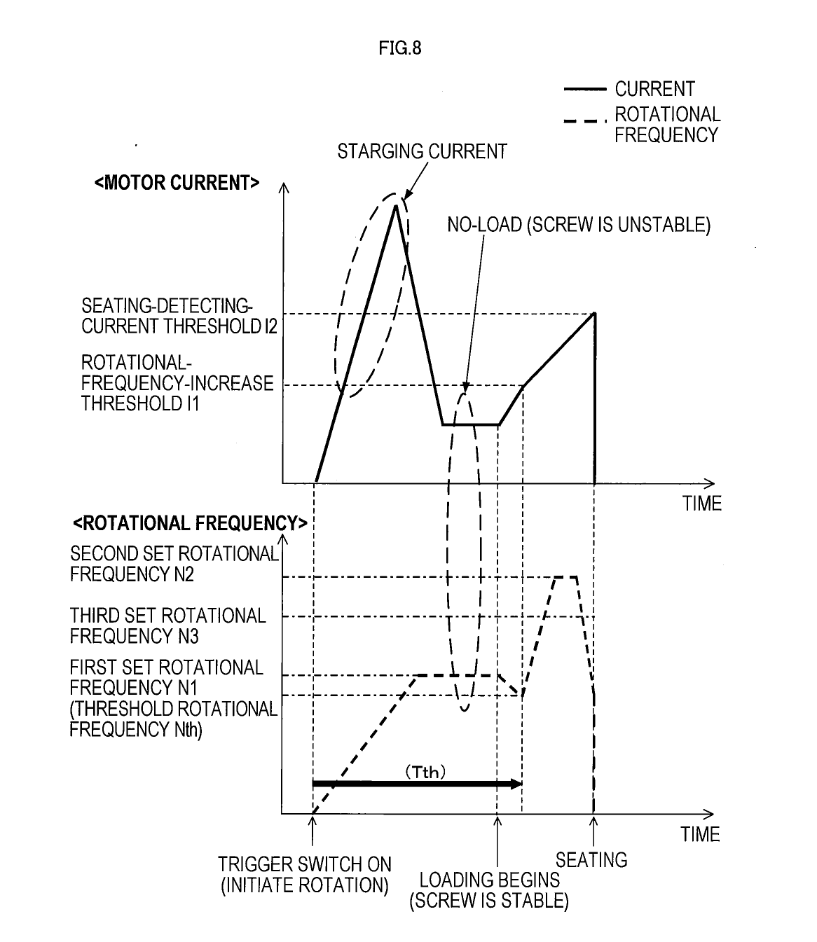

FIG. 8 shows a specific example of changes in the motor current and the rotational frequency when the motor 20 is controlled by the motor control process in FIG. 7. Among each waveform illustrated in FIG. 8, waveforms from the initiation to the seating are the same as the waveforms from the initiation to the seating of the already mentioned example in FIG. 6. In the example in FIG. 6, the rotation is continued without stopping after the seating, and the tightening torque increases to perform strikes as a result; however, in the example in FIG. 8, it is obvious from the figures that current flow to the motor 20 is stopped when the seating is detected, and the rotation of the motor 20 is stopped as a result.

As mentioned above, an excessively firm tightening of the screw after the seating can be reduced also by stopping the rotation of the motor 20 after the seating; thereby, the tightening can be finished in a favorable condition.

In the above embodiment, it is configured to set the rotational-frequency-increase threshold I1 as the condition for increasing rotational frequency, and if the motor current becomes equal to or more than this rotational-frequency-increase threshold I1, set the set rotational frequency to the second set rotational frequency N2; nevertheless, there may be other various options for the condition for increasing rotational frequency. Among various physical quantities measurable (observable) inside the power tool 1, for example, a physical quantity other than the motor current may be used to set the condition for increasing rotational frequency.

A specific example is that the condition for increasing rotational frequency may be set based on the rotational frequency of the motor 20. As it is explained with reference to FIG. 6, when the motor 20 begins to be loaded as the screw begins to drive into the target material, the rotation of the motor 20 decreases. For this reason, as stated in brackets in FIG. 6, the threshold rotational frequency Nth may be set taking into consideration things such as the actual rotational frequency of the motor at the time the motor begins to be under load, and if the rotational frequency of the motor becomes equal to or lower than this threshold rotational frequency Nth, the set rotational frequency may be set to the second set rotational frequency N2.

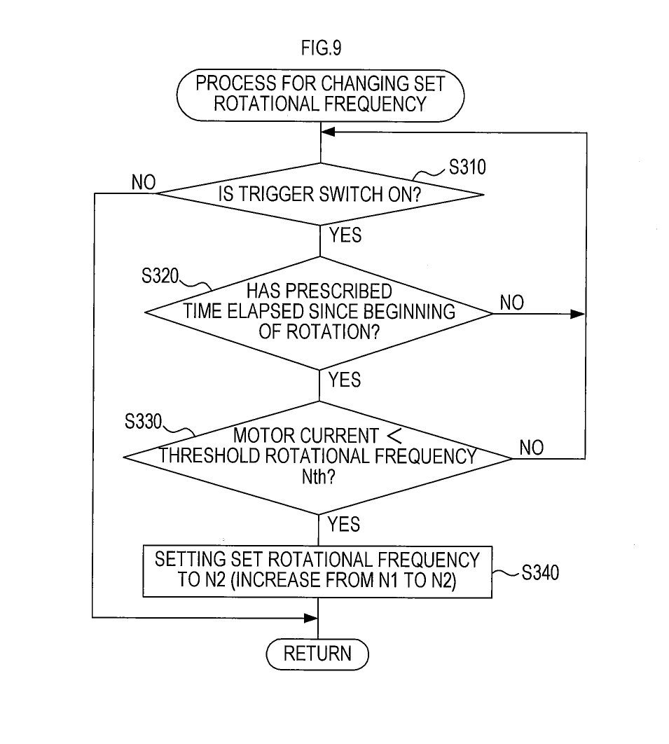

In order to practice such operation in the controller 31, processes illustrated in FIG. 9 may be applied to the process of changing set rotational frequency at step S140 of the motor control process in FIG. 4. In the process of changing set rotational frequency in FIG. 9, it is determined first at step S310 whether the trigger switch 10 is turned on. If the trigger switch 10 is off, the process moves on to step S150 (FIG. 4); if the trigger switch 10 is on, it is determined at step S320 whether the prescribed time has elapsed since the beginning of rotation.

The process goes back to step S310 from S320 until the prescribed time has elapsed since the beginning of rotation, and when the prescribed time has elapsed since the beginning of rotation, the process moves on to step S330 from S320. It is determined at step S330 whether the rotational frequency of the motor is equal to or lower than the threshold rotational frequency Nth. The process goes back to step S310 during the time that the rotational frequency of the motor is higher than the threshold rotational frequency Nth; when the rotational frequency of the motor becomes equal to or lower than the threshold rotational frequency Nth, the process moves on to step S340 to set the set rotational frequency to the second set rotational frequency N2.

Thus, the setting can be changed to the second set rotational frequency N2 as the screw is in a stable condition also by utilizing the changes in the rotational frequency of the motor and appropriately setting the threshold rotational frequency Nth.

The condition for increasing rotational frequency may be set based on, for example, an elapsed time since the motor is initiated, instead of the motor current and rotational frequency of the motor. As it is also obvious from FIG. 6, if a certain extent of time has elapsed after turning the trigger switch 10 on to begin the tightening of the screw (initiating the motor), it is anticipated that the screw has driven into the target material and in stable condition under a normal operation. Therefore, as illustrated in brackets in FIG. 6, a normally required time from the beginning of the rotation until the screw drives into the target material may be anticipated empirically or experimentally, based on which the threshold elapsed time Tth may be set. If an elapsed time after the initiation of the motor is equal to or more than this threshold elapsed time Tth, the set rotational frequency may be set to the second set rotational frequency N2.

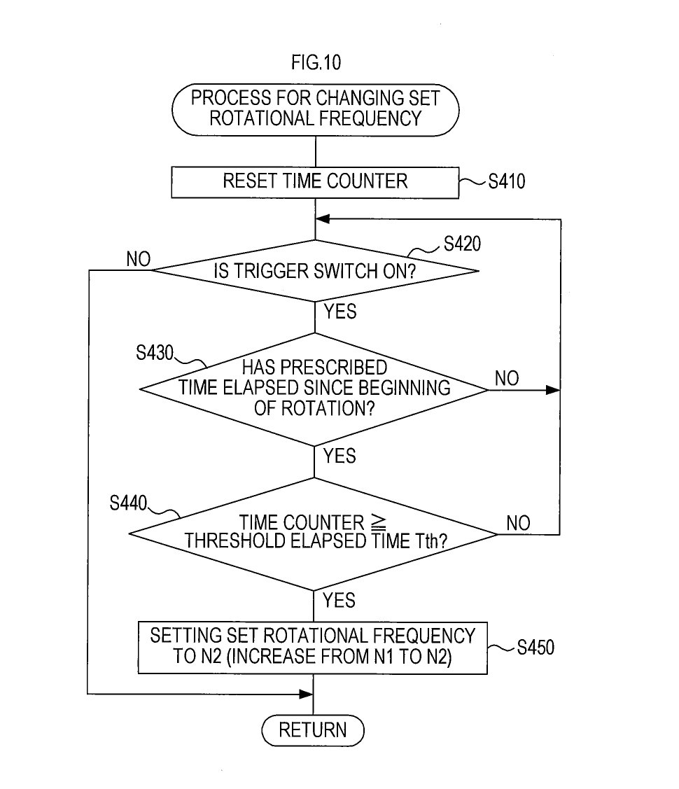

In order to practice such operations in the controller 31, processes illustrated in FIG. 10 may be applied to the process of changing set rotational frequency at step S140 of the motor control process in FIG. 4. In the process of changing set rotational frequency in FIG. 10, a time counter is reset first at step S410. The time counter is a timer disposed in the controller 31 and regularly counts a counting value by an interruption process. The elapsed time can be measured from zero by resetting the time counter.

After the time counter is reset at step S410, it is determined at step S420 whether the trigger switch 10 is turned on. If the trigger switch 10 is off, the process moves on to step S150 (FIG. 4). On the other hand, if the trigger switch 10 is on, it is determined at step S430 whether the prescribed time has elapsed since the beginning of rotation.

The process goes back to step S420 from S430 until the prescribed time has elapsed since the beginning of rotation, and when the prescribed time has elapsed since the beginning of rotation, the process moves on to step S440 from S430. It is determined at step S440 whether the elapsed time after initiating the motor is equal to or more than the threshold elapsed time Tth. The process goes back to step S420 during the time the elapsed time does not reach the threshold elapsed time Tth. On the other hand, when the elapsed time becomes equal to or more than the threshold elapsed time Tth, the process moves on to step S450 to set the set rotational frequency to the second set rotational frequency N2.

As described above, the setting can be changed to the second set rotational frequency N2 as the screw is in a stable condition also by utilizing the elapsed time since the initiation of the motor and appropriately setting the threshold elapsed time Tth.

Various conditions for increasing rotational frequency may be set other than the above-mentioned rotational frequency of the motor and elapsed time after initiating the motor, as long as the setting can be changed to the second set rotational frequency N2 in an appropriate timing. In other words, the setting may be changed to the second set rotational frequency N2 by setting various conditions for increasing rotational frequency, as long as the setting can be changed at least after a timing in which a screw enhances its stability even slightly by driving even a little into the target material.

In the above embodiment, the starting current flows immediately after the initiation of the motor 20; therefore, in order to avoid mistakenly changing the set rotational frequency because of this starting current, it is configured to wait for a prescribed time to elapse after initiating the motor before executing processes such as determining to change the set rotational frequency. Nevertheless, if the starting current is small or ignorable, it is not necessarily required to wait for the prescribed time to elapse in this way. The starting current can be reduced, for example, not by fixing the rotational frequency immediately after the initiation to the first set rotational frequency N1, but by adopting a so called soft-start, in which the rotational frequency immediately after the initiation is gradually increased from zero to the first set rotational frequency N1.

So far in the explanations, conditions based on three (following three, three factors), motor current, rotational frequency of the motor, and elapsed time after the initiation, are each illustrated as conditions for increasing rotational frequency. Among these three, any two or all three may be combined.

If, for example, a condition that the motor current is equal to or more than the rotational-frequency-increase threshold I1 (hereinafter referred to as “first condition”) and a condition that the rotational frequency of the motor is equal to or lower than the threshold rotational frequency Nth (hereinafter referred to as “second condition”) are both cleared, the set rotational frequency may be set to the second set rotational frequency N2. If, for example, even one of the first condition or the second condition is cleared, the set rotational frequency may be set to the second set rotational frequency N2. If, for example, a condition that the elapsed time since the initiation of the motor is equal to or more than the threshold elapsed time Tth (hereinafter referred to as “third condition”) is added, and if all three, or any one, or any two of these first condition, the second condition, and the third condition are cleared, the set rotational frequency may be set to the second set rotational frequency N2.

In other words, upon determining a timing to change the setting to the second set rotational frequency N2, it may be appropriately decided as to on what basis and on how many types of bases the timing should be determined, and if there are multiple types of bases to use, as to how these multiple types of bases are combined to determine the timing, etc.

In the above embodiment, a bridge circuit with 6 elements is illustrated as a motor drive circuit 33; still, it is absolutely an example, and thus there may be a variety of specific drive circuits for rotating the motor 20. It is also absolutely an example that the motor 20 is a brushless motor.

In the above embodiment, an example of applying the present invention to the TEKS mode is illustrated; still, it is also absolutely an example, and thus the present invention may be applied to other operational modes (for example, to the drill mode and clutch mode). The present invention can be applied not only to the 5-mode impact driver illustrated in the above embodiment, but also to any types of power tools for tightening a screw to a target material. When tightening a type of screw particularly such as a drill screw, which is tightened as the screw itself drills a hole into a target material, application of the present invention makes it possible to expeditiously tighten the screw while maintaining favorable performance.

1. A power tool that tighten a screw to a tightening-target-object comprising;
a motor for rotationally driving an output axis to which a tool element is attached;
an input-operation receiving unit for receiving an input operation from outside to rotate the motor;
a motor controlling device for controlling the motor to rotate the motor at a rotational frequency depending on a content of the input operation received by the input-operation receiving unit, wherein a preset maximum rotational frequency is an upper limit;
a first setting unit for setting the maximum rotational frequency to a given first maximum rotational frequency when the motor is initiated;
an increase-condition determiner for determining whether the power tool has cleared a given condition for increasing rotational frequency after the motor is initiated; and
a second setting unit for setting the maximum rotational frequency to a given second maximum rotational frequency that is higher than the first maximum rotational frequency, if a condition for increasing rotational frequency is cleared.

2. The power tool according to claim 1 comprising a physical-quantity detector for detecting one or multiple types of physical quantities related to operating state of the power tool,
wherein the increase-condition determiner determines that the condition for increasing rotational frequency is cleared, if a part or all of the one or multiple types of physical quantities detected by the physical-quantity detector reach a preset threshold for the each of the physical quantities.

3. The power tool according to claim 2,
wherein the physical-quantity detector detects a current of the motor as the physical quantity, and
wherein the increase-condition determiner determines that the condition for increasing rotational frequency is cleared, if the current of the motor detected by the physical-quantity detector is equal to or more than a threshold current as the above threshold.

4. The power tool according to claim 2,
wherein the physical-quantity detector detects the rotational frequency of the motor as the physical-quantity, and
wherein the increase-condition determiner determines that the condition for increasing rotational frequency is cleared, if the rotational frequency of the motor detected by the physical-quantity detector is equal to or lower than a threshold rotational frequency as the threshold.

5. The power tool according to claim 2,
wherein the physical-quantity detector detects an elapsed time after initiation of the motor as the physical quantity, and
wherein the increase-condition determiner determines that the condition for increasing rotational frequency is cleared, if the elapsed time detected by the physical-quantity detector is equal to or more than a threshold elapsed time as the threshold.

6. The power tool according to claim 1, comprising:
a seating detector for detecting seating of the screw on the tightening-target-object, the screw is rotated by the tool element; and
a third setting unit for setting the maximum rotational frequency to a given third maximum rotational frequency that is smaller than the second maximum rotational frequency, if the seating is detected by the seating detector after the second setting unit sets the maximum rotational frequency to the second maximum rotational frequency.

7. The power tool according to claim 1, comprising a seating detector for detecting seating of the screw on the tightening-target-object, the screw is rotated by the tool element,
wherein the motor controlling device stops the motor, if the seating is detected by the seating detector after the second setting unit sets the maximum rotational frequency to the second maximum rotational frequency.
